(19) United States
(12) Patent Application Publication
(10) Pub. No.: US 2002/0167171 A1
(43) Pub. Date: Nov. 14, 2002

(54) Sanitary Fitting

(76) Inventors: Ulrich Becker, Flussbach (DE); Dietmar Hildebrand, Trier (DE); Jurgen Sponheimer, Klausen (DE)

Correspondence Address: NIXON PEABODY, LLP, 8180 GREENSBORO DRIVE, SUITE 800, MCLEAN, VA, 22102, US

(21) Appl. No.: 09/804,431

(22) Filed: Jul. 11, 2001

Related U.S. Application Data
(63) Continuation of application No. PCT/EP98/08008, filed on Dec. 9, 1998.

(30) Foreign Application Priority Data
Dec. 9, 1997 (DE) 197 54 585.8
Jan. 8, 1998 (DE) 198 00 399.4

(51) Int. Cl. F16L 17/00

(52) U.S. Cl. 285/363; 285/124.1

(57) ABSTRACT

The invention relates to a sanitary fitting comprising at least one supply pipe (1, 2) and/or one connecting element (10) for connection to a connecting pipe or a flexible hose, in addition to at least one fitting component (5) with an accommodating opening (3, 4) for the supply pipe (1, 2) or connecting element (10), whereby the supply pipe (1, 2) or the connecting element (10) is provided with a supporting rim (6) which rests against the component (5) and is arranged in the accommodating opening (3, 4) of the component (5) and securely connected thereto (5). In order to connect the supply pipe (1, 2) or connecting element (10) to the component (5) of the sanitary fitting in a simple, economical manner, the supply pipe (1, 2) or connecting element (10, 11) is engaged in the accommodating opening (3, 4) of the component by means of a flange (7) which is located at a specific distance from the supporting rim (6).

The invention relates to a sanitary fitting comprising at least one supply pipe and/or one connecting element for connection to a connecting pipe or flexible hose, in addition to at least one fitting component with an accommodating opening for the supply pipe or connecting element whereby the supply pipe or the connecting element is provided with a supporting rim which rests against the component and is arranged in the accommodating opening of the component and securely connected thereto.

A sanitary fitting of the above-mentioned type having inlet pipes for hot and cold water has been known in practice for a long time. DE 37 07 705 A1 describes a discharge fitting in which the supply pipes are soldered to the openings of the water-channelling ducts of the discharge fittings. Furthermore, it is known from 23 31 000 C2 to attach both supply pipes for hot and cold water to the valve body of a single-lever mixer using a soldered joint. The disadvantage of the aforementioned prior art is that the manufacture of a soldered joint is relatively time and cost intensive. In addition, mordanting of the soldered area is necessary after its manufacture, which extends the time needed and increases the cost of the manufacturing process. The aforementioned problem arises, of course, in sanitary fittings, too, which have connecting elements having flexible hoses for connection. The connection elements are also soldered in prior art.

Object of the present invention is to provide a sanitary fitting of the type above in which the supply pipe or the connecting element can be simply and quickly connected securely to the sanitary fitting.

The object is met with a sanitary fitting as described above in that the supply pipe or the connecting element is inserted in the accommodating opening of the fitting component via a flange set apart from the supporting rim. The insertion is easily incorporated into the manufacturing process of sanitary fittings using a special machine. As a result of the invention, a purely mechanical connection of at least one supply pipe or of the connecting element to the sanitary fitting is provided without having to solder and subsequently to perform after-treatment in the form of mordanting. It has been established that the invention has a substantial cost advantage over the known soldering joint.

It is fundamentally known from DE 31 19 313 C2 to provide supply pipes having a flange on the end toward the fitting for the creation of a collar or support rim in order to keep the supply pipe in the base part of the sanitary fitting. However, with the sanitary fittings known from DE 31 19 313 C2, the supply pipe is not attached to the base part with the flange, but is only axially fixed to a step in the through hole of the base part on which the collar or support rim is laid. Accordingly, the supply pipe has only the flanged supporting rim and due to this, cannot be inserted into the base part and be securely connected to it. While the supply pipe is securely connected to the corresponding fitting component held by the supply pipe according to the invention and in the prior art, from which the invention starts which uses the soldering joint, this is not the case for the sanitary fitting known from DE 31 19 313 C2. Instead, it is possible, there, to pull the supply pipe out of the base part after freeing the base part.

Further advantageous forms of the invention arise in the sub-claims.

Preferred embodiments of the present invention are now explained with reference to the drawing.

It shows:

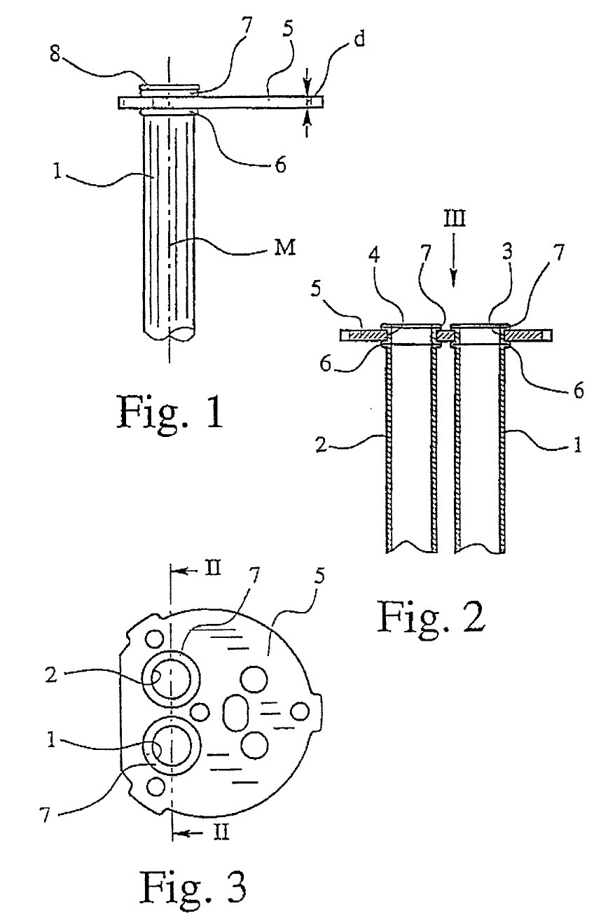

FIG. 1 a side view of supply pipes held in a base plate,

FIG. 2 a view of the cross section of the base plate from FIG. 3 along line II-II from FIG. 3,

FIG. 3 a top view of the base plate from FIG. 2 seen in the direction of the arrow III from FIG. 2,

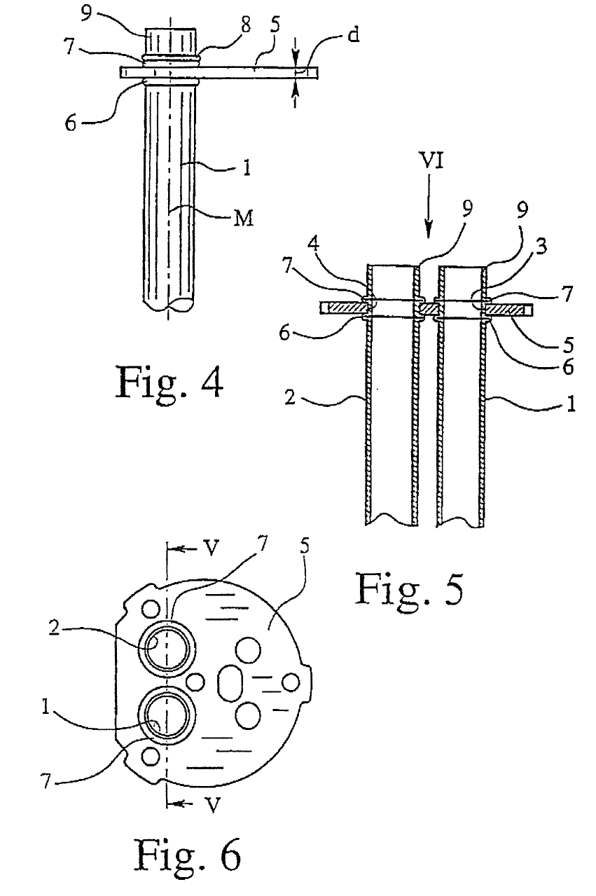

FIG. 4 a side view of supply pipes held in a base plate,

FIG. 5 a view of the cross section of the base plate from FIG. 6 along line V-V from FIG. 6,

FIG. 6 a top view of the base plate from FIG. 5 seen in the direction of the arrow VI from FIG. 5,

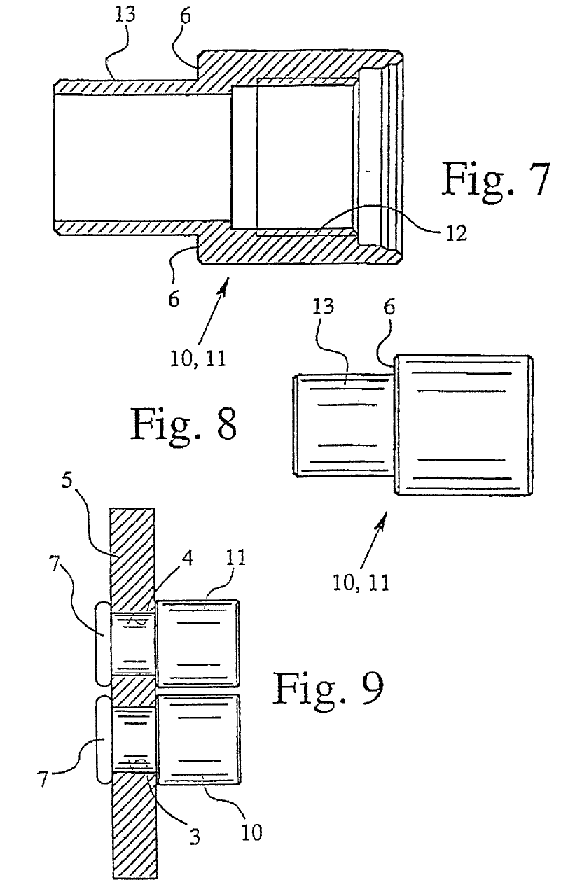

FIG. 7 a view of the cross section of the connecting element according to the invention,

FIG. 8 a side view of the connecting element from FIG. 7 and

FIG. 9 a view of the cross section of two connecting elements held by a base plate.

Presently, a sanitary fitting known per se is being dealt with which is not individually shown. The sanitary fitting can be constructed in the form of a discharge fitting as is known from DE 37 07 705 A1. However, it can also be constructed—as is preferred—as a single-lever mixer as is known from DE 23 31 000 C2, DE 31 19 313 C2 or DE-A-4,051,869. A description of the fundamental details of the construction of a sanitary fitting are left out here. In order to avoid repetition explicit references are made to the aforementioned documents and their content concerning this matter are hereby incorporated by reference into the content of the present application.

The sanitary fitting according to the invention has principally at least one, preferably two, supply pipes 1, 2 as shown in FIG. 1 to 6 which are provided for the connection to corresponding connecting pipelines, namely a cold water connecting pipeline and a hot water connecting pipeline which are not individually shown here. Each of the two supply pipes 1, 2 are placed in an accommodating opening 3, 4 of a fitting component 5 of the sanitary fitting. In the mounted state of the supply pipes 1, 2, they are securely connected to the fitting component 5.

It is essential that each of the supply pipes 1, 2 is inserted in the corresponding, accommodating opening 3, 4 of the fitting component via a supporting rim 6 and a flange 7 and is therewith securely held to the fitting component. The fitting component 5 and the supply pipes 1, 2 which are each inserted in the accommodating openings 3, 4 represent a finished, total package for application. The supporting rim 6, is presently designed as a further flange.

As seen especially in FIG. 1 and 2 on the one hand and 4 and 5 on the other, the distance from the lower, flanged supporting rim 6 to the upper flange 7 corresponds approximately to the thickness d of the fitting component 5. Hereby, the supply pipes 1, 2 are affixed in the axial direction in the accommodating openings 3, 4 and, thus, do not move in the direction of the central longitudinal axis M of the corresponding supply pipes 1, 2.

In the embodiment shown in FIG. 1 to 3, the supply pipes 1, 2 do not extend beyond the flange 7. Accordingly, the supply pipes 1, 2 end at the upper flange 7. For this embodiment, an O-ring 8, shown only in FIG. 1, is used as a sealant for obtaining an axial seal with a component of the sanitary fitting following the fitting component 5 in the direction of the flow of water.

In the embodiment shown in FIG. 4 to 6, each of the supply pipes 1, 2 has an end section 9 above the flange 7. The supply pipe 1, 2 thus, does not end at the flange 7 as is the case in the embodiment according to FIG. 1 to 3. An O-ring 8, shown only in FIG. 4, is also placed on the end section 9 as a sealant which is provided for obtaining a radial seal with a component of the sanitary fitting following the fitting component 5 in the direction of flow.

By the way, it is also principally possible to allow one of the supply pipes to end at the upper flange and to provide the other supply pipe with an end section.

On the connecting side, each of the supply pipes 1, 2 can either be directly connected to the pertaining connecting pipe or, however, initially with a flexible hose which is connected to the pertaining, connecting-side end of the supply pipe.

The fitting component 5, itself, is presently constructed as a base plate or intermediate piece of the sanitary fitting, wherein a valve unit of the sanitary fitting is provided above the fitting component.

The manufacture of the sanitary fitting or the unit consisting of both supply pipes 1, 2 and the fitting component 5 results in such a way that the supply pipes 1, 2 used for the manufacture of a flange, i.e. the supporting rim 6, are first upset and then the supply pipes 1, 2 are inserted in the respective accommodating openings 3, 4 of the fitting component 5 until the supporting rim 6 comes in contact with the fitting component 5. Subsequently, the supply pipes 1, 2 used for the manufacture of the flange 7 are upset again. The upsetting ensues via a special machine which is easily integrated into the manufacture process.

An embodiment is shown in FIG. 7 to 9 in which, instead of supply pipes, connecting elements 10, 11 are provided which are inserted in the respective accommodating openings 3, 4 of the fitting component 5 via the flange 7 and supporting rim 6 and are therewith securely connected to the fitting component 5. In contrast with the embodiment described above, the supporting rim 6 is not designed as a further flange in the connecting element, but as a material thickening in the connecting element 10, 11 designed as a one-piece fitting component. The connecting element 10, 11, itself, which can also be called a (connective-) nipple, has internal threading 12 for a direct connection to the flexible hose. On the connecting side, following the internal threading, the internal diameter of the connecting element 10, 11 multiply increases outwardly which can be seen especially in FIG. 7.

The manufacture of the unit consisting of both connecting elements 10, 11 and the fitting component 5 results in such a way that the connecting elements 10, 11 which are not yet upset as shown in FIG. 7 and 8 are inserted into the accommodating openings 3, 4 of the fitting component 5 until the fitting component 5 comes in contact with the corresponding supporting rim 6. For the insertion of the connecting elements 10, 11, following the thickened supporting rim 6, the elements have a pipe section 13 which has a smaller external diameter than the supporting rim 6. After the insertion of the pipe section 13 in the accommodating opening 3, 4, the pipe sections 13, extending about 5 mm beyond the fitting component 5 according to the present embodiment are upset to manufacture the flange 7 which then extends only 1.5 mm beyond the fitting component 5.

Since the supply pipes 1, 2 or the connecting elements 10, 11 respectively in the manufacture of the connection to the fitting component 5 must be upset and the fitting component 5 also suffers from stress when the supply pipes 1, 2 or the connecting elements 10, 11 are being upset, the supply pipes 1, 2 or the connecting elements 10, 11 respectively and the fitting component 5 are correspondingly designed concerning their material. The supply pipes 1, 2 or the connecting elements 10, 11 can thereby—as in the prior art—for example, be made of copper or another material that can be upset while, e.g. the fitting component 5 is made of steel.

1. Sanitary fitting comprising at least one supply pipe (1, 2) and/or one connecting element (10, 11) for connection to a connecting pipe or flexible hose, in addition to at least one fitting component (5) with an accommodating opening (3, 4) for the supply pipe (1, 2) or connecting element (10, 11) whereby the supply pipe (1, 2) or the connecting element (10, 11) is provided with a supporting rim (6) which rests against the component (5) and is arranged in the accommodating opening (3, 4) of the component (5) and securely connected thereto (5) characterized in that the supply pipe (1, 2) or the connecting element (10, 11) is inserted in the accommodating opening (3, 4) of the fitting component (5) via a flange (7) set apart from the supporting rim (6).

2. Sanitary fitting according to claim 1, characterized in that the supporting rim (6) is constructed as a further flange or from a material thickening.

3. Sanitary fitting according to claim 1 or 2, characterized in that the distance from the supporting rim (6) to the flange (7) corresponds approximately to the thickness (d) of the fitting component (5) so that the supply pipe (1, 2) or the connecting element (10, 11) is axially affixed in the fitting component (5).

4. Sanitary fitting according to any of claims 1 to 3, characterized in that the supply pipe (1, 2) or the connecting element (10, 11) ends at the flange (7) and that, preferably, a sealant, especially an O-ring (8) is laid on the flange (7) in order to obtain an axial seal.

5. Sanitary fitting according to any of claims 1 to 3, characterized in that the supply pipe (1, 2) or the connecting element (10, 11) has an end section (9) above the flange (7) and that, preferably, a sealant, especially an O-ring (8) is placed on the end section (9) in order to obtain a radial seal.

6. Sanitary fitting according to any of claims 1 to 5, characterized in that the supply pipe (1, 2) is connected to a flexible hose on the connecting end or that the connecting element (10, 11) has an internal threading (12) on the connecting end.

7. Sanitary fitting according to any of claims 1 to 6, characterized in that the fitting component (5) is constructed as a base plate or intermediate piece of the sanitary fitting, wherein a valve unit of the sanitary fitting is provided above the fitting component (5).

8. Method for the production of a sanitary fitting according to any of the above claims wherein the supply pipe used for construction of the flanged supporting rim is upset, the supply pipe is inserted into the accommodating opening of the fitting component until the supporting rim comes in contact with the fitting component and the supply pipe used for the manufacture of the flange is upset.

9. Method for the production of a sanitary fitting according to any of the above claims, wherein the connecting element is inserted into the accommodating opening of the fitting component until the supporting rim comes in contact with the fitting component and the supply pipe is subsequently upset for the manufacture of a flange.
